(19) United States
(12) Patent Application Publication
(10) Pub. No.: US 2026/0235899 A1
(43) Pub. Date: Aug. 13, 2026

(54) OPTICAL WAVEGUIDE ELEMENT AND OPTICAL MODULATION DEVICE USING SAME, AND OPTICAL TRANSMISSION DEVICE

(71) Applicant: SUMITOMO OSAKA CEMENT CO., LTD., Tokyo (JP)

(72) Inventors: Yuji HAYAMI, Tokyo (JP); Yu KATAOKA, Tokyo (JP); Kosuke OKAHASHI, Tokyo (JP)

(73) Assignee: SUMITOMO OSAKA CEMENT CO., LTD., Tokyo (JP)

(21) Appl. No.: 19/149,016

(22) PCT Filed: Mar. 30, 2023
(86) PCT No.: PCT/JP2023/013109

§ 371 Date: Jul. 17, 2025

(51) Int. Cl. G02F 1/035

(52) U.S. Cl. CPC G02F 1/0353

(57) ABSTRACT

An object of the present invention is to provide an optical waveguide device that is capable of reducing a curvature radius of an optical waveguide and that suppresses coupling between a TE mode and a TM mode.

In the present invention, an optical waveguide device includes a rib optical waveguide 10, in which a rib optical waveguide includes a straight linear part AR1 and a curved part AR3 configured to have a constant curvature, a curvature transition part AR2 in which a curvature continuously changes connects the straight linear part AR1 to the curved part AR3, a height and a width of the rib optical waveguide are different between the straight linear part and the curved part, and the curvature transition part AR2 is formed such that the height and width of the rib optical waveguide continuously change from a height and a width of the straight linear part to a height and a width of the curved part, respectively.

### TECHNICAL FIELD

The present invention relates to an optical waveguide device, and an optical modulation device and an optical transmission apparatus using the same, and particularly to an optical waveguide device including a rib optical waveguide.

### BACKGROUND ART

In the field of optical communication or in the field of optical measurement, optical waveguide devices such as an optical modulator that is obtained by forming an optical waveguide on a substrate of lithium niobate (LN) or the like having an electro-optic effect and that is provided with a modulation electrode which modulates a light wave propagating through the optical waveguide have been widely used.

In a driver-integrated modulator such as a high bandwidth coherent driver modulator (HB-CDM), for example, it is required to further reduce a size of the entire package by incorporating a driver circuit for driving an optical waveguide device into a case together with the optical waveguide device. Thus, a size of the optical waveguide device is also reduced, and a thin plate on which a rib optical waveguide having a width and height of approximately 1 μm is formed is used.

As illustrated in FIG. 1, from a viewpoint of achieving a low drive voltage, reduction of the size of the optical waveguide device, particularly the optical waveguide device using an LN substrate 1, adopts a folded structure of an optical waveguide 10 in order to secure an electrode length of a modulation action portion AP for applying a radio frequency signal (an RF signal) and an electrode length of a bias action portion DC for applying a bias voltage for phase control, as large as possible. In order to show a shape of the optical waveguide 10 in an understandable manner, an electrode that applies an electric field to the optical waveguide is not illustrated in FIG. 1. While a plurality of optical waveguides are present in FIG. 1, the representative optical waveguide 10 is illustrated.

However, in the configuration of the rib optical waveguide in the related art, a minimum curvature radius of the folded waveguide has been a limiting factor for size reduction as a chip size. In order to reduce the size of the optical waveguide device having the folded structure of the optical waveguide 10 as illustrated in FIG. 1, it is effective to reduce the curvature radius of the folded waveguide as much as possible.

FIG. 2 is a cross-sectional view taken along alternate long and short dash line A-A′ in FIG. 1. The LN substrate 1 on which the rib optical waveguide 10 is formed has a thickness of 10 μm or lower, and a thickness of 1 μm or lower has been achieved in recent years. A holding substrate 3 of Si or the like is joined to the LN substrate 1 through an intermediate layer 2 of SiO₂ or the like in order to increase mechanical strength.

As means for reducing the curvature radius, for example, an effective refractive index of the optical waveguide is increased in the optical waveguide device including the rib optical waveguide 10. The effective refractive index can be further increased by further increasing a height of a rib of the optical waveguide or a width of the rib, as disclosed in Patent Literature No. 1.

However, in a case where an X-cut LN substrate is used in the substrate on which the optical waveguide is formed, a TE mode having high modulation efficiency (a change in the refractive index with respect to the electric field application) propagates through the rib waveguide. In order to suppress coupling (polarization crosstalk) between the TE mode and a TM mode as illustrated in Patent Literature No. 2, it is necessary to set effective refractive indices of the TE mode and the TM mode to be different from each other by setting different propagation speeds between the TE mode and the TM mode.

The effective refractive indices of the TE mode and the TM mode change depending on the height and the width of the rib optical waveguide. Particularly, the effective refractive index of the TE mode depends on the width of the rib, and the effective refractive index of the TM mode depends on the height of the rib.

LN which is a birefringent material has equal refractive indices between the TE mode and the TM mode in an optical waveguide parallel to a Z crystal axis direction, and the refractive index of the TE mode is lower than the refractive index of the TM mode in an optical waveguide parallel to a Y crystal axis direction because of characteristics of the material. In the optical waveguide parallel to the Z crystal axis direction, the refractive index of the material causes equal propagation speeds between the TE mode and the TM mode, polarization crosstalk is more likely to occur. That is, it is necessary to set the effective refractive index of the TE mode to be higher than the effective refractive index of the TM mode, and it is necessary to set the width of the rib of the optical waveguide to be larger than the height of the rib. The reason why the effective refractive index of the TE mode is not set to be higher than the effective refractive index of the TM mode is that a difficulty of a process for setting the width of the rib to be smaller than the height of the rib is high, and coupling between the high-order TM mode and the fundamental TE mode is prevented.

Setting the height of the rib or the width of the rib to be larger than that in the related art poses problems such as an optical insertion loss caused by an increase in a light scattering loss and deterioration of an extinction ratio caused by an increase in a likelihood of excitation of a high-order mode light beam in the optical waveguide.

In order to suppress the light scattering loss and excitation of the high-order mode light beam, an optical waveguide having the height of the rib or the width of the rib in the related art may be adopted in a straight linear portion of the rib optical waveguide, and an optical waveguide having an increased height of the rib or an increased width of the rib may be adopted in only a curved portion. In this case, a coupling loss of light occurs because the height of the rib or the width of the rib discontinuously changes in a boundary part between the straight linear portion and the curved portion.

### CITATION LIST

### Patent Literature

Patent Literature No. 1: Japanese Laid-open Patent Publication No. 2021-157065

Patent Literature No. 2: Japanese Laid-open Patent Publication No. 2022-56979

### SUMMARY OF INVENTION

### Technical Problem

An object to be solved by the present invention is to solve the above problem and provide an optical waveguide device that is capable of reducing a curvature radius of an optical waveguide and that suppresses coupling between a TE mode and a TM mode. It is also an object to provide an optical modulation device and an optical transmission apparatus using the optical waveguide device.

### Solution to Problem

In order to solve the object, an optical waveguide device, an optical modulation device, and an optical transmission apparatus of the present invention have the following technical features.

(1) An optical waveguide device includes a rib optical waveguide, in which the rib optical waveguide includes a straight linear part and a curved part configured to have a constant curvature, and a curvature transition part in which a curvature continuously changes connects the straight linear part to the curved part, a height and a width of the rib optical waveguide are different between the straight linear part and the curved part, and the curvature transition part is formed such that the height and width of the rib optical waveguide continuously change from a height and a width of the straight linear part to a height and a width of the curved part, respectively.

(2) In the optical waveguide device according to (1), a relationship between the height and width of the rib optical waveguide is such that a value of the height is smaller than a value of the width.

(3) In the optical waveguide device according to (1), in the curvature transition part, the height and width of the rib optical waveguide are set to increase as a curvature radius decreases.

(4) In the optical waveguide device according to (1), a height from a bottom surface of a substrate on which the rib optical waveguide is formed, to an upper surface of a rib of the rib optical waveguide is set to be constant even in a case where the height of the rib optical waveguide changes.

(5) An optical modulation device includes the optical waveguide device according to any one of (1) to (4), a case accommodating the optical waveguide device, and an optical fiber through which a light wave is input into the optical waveguide device or output from the optical waveguide device.

(6) In the optical modulation device according to (5), a modulation electrode that modulates a light wave propagating through the optical waveguide is provided in the substrate, and an electronic circuit that amplifies a modulation signal to be input into the modulation electrode is provided inside the case or outside the case.

(7) An optical transmission apparatus includes the optical modulation device according to (6), and an electronic circuit that outputs a modulation signal causing the optical modulation device to perform a modulation operation.

### Advantageous Effects of Invention

According to the present invention, an optical waveguide device includes a rib optical waveguide, in which the rib optical waveguide includes a straight linear part and a curved part configured to have a constant curvature, and a curvature transition part in which a curvature continuously changes connects the straight linear part to the curved part, a height and a width of the rib optical waveguide are different between the straight linear part and the curved part, and the curvature transition part is formed such that the height and width of the rib optical waveguide continuously change from a height and a width of the straight linear part to a height and a width of the curved part, respectively. Thus, an optical waveguide device that is capable of reducing a curvature radius of a curved part of an optical waveguide and that suppresses coupling between a TE mode and a TM mode can be provided. In addition, an optical loss can be reduced by continuously changing a height of a rib or a width of the rib. In addition, an optical modulation device and an optical transmission apparatus using the optical waveguide device achieving such an advantageous effect can be provided.

### BRIEF DESCRIPTION OF DRAWINGS

FIG. 1 A plan view illustrating an example of an optical waveguide device in the related art.

FIG. 2 A cross-sectional view taken along alternate long and short dash line A-A′ in FIG. 1.

FIG. 3 A plan view illustrating a part of an optical waveguide used in an optical waveguide device of the present invention.

FIGS. 4A and 4B Cross-sectional views taken along alternate long and short dash lines B-B′ and C-C′ in FIG. 3.

FIGS. 5A, 5B, and 5C Graphs for describing a state of a change in a curvature radius, a width of a rib, and a height of the rib in the optical waveguide in FIG. 3.

FIG. 6 A diagram illustrating another cross-sectional shape of the optical waveguide used in the optical waveguide device of the present invention.

FIG. 7 A plan view illustrating an example of a folded waveguide used in the optical waveguide device of the present invention.

FIG. 8 A plan view illustrating another example of the folded waveguide used in the optical waveguide device of the present invention.

FIG. 9 A plan view illustrating an example of the optical waveguide device of the present invention.

FIG. 10 A plan view illustrating an optical modulation device and an optical transmission apparatus according to the present invention.

### DESCRIPTION OF EMBODIMENTS

Hereinafter, the present invention will be described in detail using preferred examples.

In the present invention, as illustrated in FIGS. 3 to 5C, an optical waveguide device includes a rib optical waveguide 10, in which the rib optical waveguide includes a straight linear part AR1 and a curved part AR3 configured to have a constant curvature, a curvature transition part AR2 in which a curvature continuously changes connects the straight linear part AR1 to the curved part AR3, a height and a width of the rib optical waveguide are different between the straight linear part and the curved part, and the curvature transition part AR2 is formed such that the height and width of the rib optical waveguide continuously change from a height and a width of the straight linear part to a height and a width of the curved part, respectively.

As a substrate 1 on which the optical waveguide is formed, a substrate of lithium niobate (LN), lithium tantalate (LT), PLZT (lead lanthanum zirconate titanate), or the like having an electro-optic effect, a vapor-phase growth film formed of these materials, and various materials such as a semiconductor material and an organic material can be used.

As a method of forming the optical waveguide 10, a rib optical waveguide in which a part of the substrate corresponding to the optical waveguide is formed to have a protruding shape by, for example, etching a surface of the substrate other than the optical waveguide and forming grooves on both sides of the optical waveguide can be used. By using a horizontal slot waveguide in which a slot waveguide structure is formed in a thickness direction by thinning the substrate, a bending loss can be reduced.

A technique of forming a high-refractive index part on the surface of the substrate with Ti or the like using a thermal diffusion method, a proton exchange method, or the like can also be applied in accordance with the rib optical waveguide part. Particularly, for example, in a case of reducing a size of the optical waveguide device, or using a folded optical waveguide, a protruding waveguide that exhibits strong light confinement and that has a width or a height of approximately 1 μm is used.

In order to achieve velocity matching between a microwave of a modulation signal and a light wave, a thin film substrate is produced from the substrate 1 on which the optical waveguide is formed, using a method of forming a thin plate by grinding and polishing up to a thickness of 10 μm or lower, more preferably 5 μm or lower, and still more preferably lower than 1 μm (a lower limit of the thickness is preferably 0.3 μm or more), a smart cut method (a method of forming a thin film by ion implantation and peeling), or the like. The height of the rib optical waveguide is preferably set to 1 μm or lower. Alternatively, a vapor-phase growth film can be formed on another substrate to have a thickness of approximately that of the above substrate, and the film can be processed to have the above shape of the optical waveguide.

As illustrated in FIG. 2, the substrate (a thin plate or a thin film) 1 on which the optical waveguide is formed is adhesively fixed to a holding substrate 3 through an intermediate layer 2 in order to increase mechanical strength. In the present invention, this composite substrate in which the thin plate, the intermediate layer 2, and the holding substrate 3 are integrated may be referred to as the “substrate”.

A glass material or a crystal such as silicon (Si) or an alpha quartz single crystal having a low dielectric constant, sapphire, or the like of 1 mm or lower can be used in the holding substrate 3.

A material having a lower dielectric constant than the substrate 1 is used in the intermediate layer in order to cause light to be confined to the substrate 1 and to achieve a lower refractive index than the thin plate 1 and velocity matching between the light wave and an electrical signal (a microwave). Furthermore, in order to suppress application of thermal stress to the thin plate 1, a material having a similar coefficient of thermal expansion to the thin plate 1 is used. Specifically, a Si oxide film or the like of SiO₂ or the like with a thickness of 10 μm or lower is used.

As a feature of the optical waveguide device of the present invention, the height and width of the rib optical waveguide are different between the straight linear part AR1 and the curved part AR3 of the rib optical waveguide, and the curvature transition part AR2 connecting the straight linear part AR1 to the curved part AR3 is formed such that the height and width of the rib optical waveguide continuously change from the height and width of the straight linear part AR1 to the height and width of the curved part AR3, respectively. For example, in an optical waveguide folded by 90 degrees, a ratio of angles occupied by the curvature transition part AR2 and the curved waveguide AR3 having a constant curvature is configured as angle occupied by AR2: angle occupied by AR3=1:2 to 10 (degrees). The meaning of 1:2 is that an angle occupied by a bent part of AR2 corresponds to 30 degrees, and an angle occupied by a bent part of AR3 corresponds to 60 degrees.

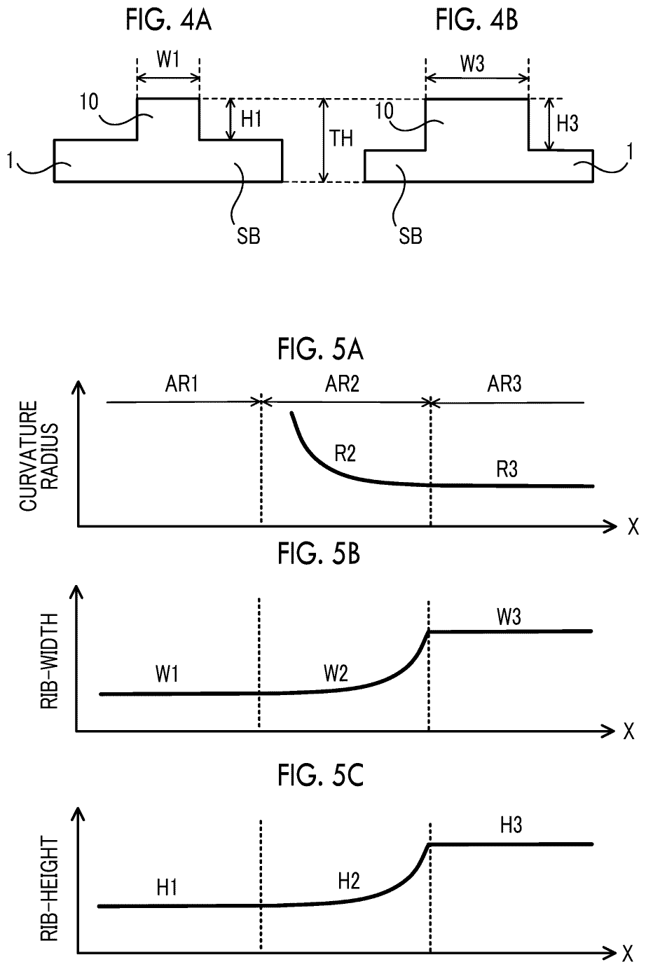

In the present invention, as illustrated in the cross-sectional view (FIG. 4A) taken along alternate long and short dash line B-B′ of FIG. 3 and the cross-sectional view (FIG. 4B) taken along alternate long and short dash line C-C′ of FIG. 3, in the straight linear part AR1 and the curved part AR3 of the rib optical waveguide illustrated in FIG. 3, a height H3 of the rib in the curved part is set to be larger than a height H1 of the rib in the straight linear part, and a width W3 of the rib in the curved part is set to be larger than a width W1 of the rib in the straight linear part. Accordingly, the curved part is set to have a higher effective refractive index of the optical waveguide than the straight linear part, and the curvature radius of the curved part can be further reduced. For example, by adopting the present configuration, the curvature radius of the curved part can be reduced by approximately 20%. In a case where the curvature radius of the curved part is 100 um in an optical waveguide in which an advancing direction of light is folded by 90 degrees, the present technique can reduce the curvature radius by 20%, and 20% downsizing (size reduction) in each of horizontal and vertical directions with respect to the entire optical waveguide folded by 90 degrees can be achieved.

In the optical waveguide device of the present invention, a relationship between the height and width of the rib optical waveguide 10 is set such that a value of the height is always smaller than a value of the width (height of rib <width of rib). Consequently, coupling between the TE mode and the TM mode is suppressed.

Furthermore, by setting a “ratio of the width of the rib and the height of the rib” of the rib optical waveguide (straight linear part W1/H1, curvature transition part W2/H2, and curved part W3/H3) to W1/H1<W2/H2<W3/H3, coupling between both modes can be more reliably suppressed. In the bent waveguide (the curved part and the curvature transition part), an optical loss can be suppressed in a case where the effective refractive index in a longitudinal direction of the substrate 1 (overlapping with a direction of the width of the rib) is higher. Thus, it is preferable to set the width of the rib to be larger than the height of the rib.

FIGS. 5A, 5B, and 5C are graphs illustrating a change in the curvature radius, the width of the rib, and the height of the rib in the straight linear part AR1, the curvature transition part AR2, and the curved part AR3 in FIG. 3.

The curvature radius continuously changes in the curvature transition part AR2 (a curvature radius R2) and reaches a constant value of a curvature radius R3 in the curved part.

For the width of the rib, the width W3 of the rib in the curved part (having a constant curvature) AR3 is set to be larger than the width W1 of the rib in the straight linear part AR1. In the curvature transition part AR2, the width of the rib is continuously changed in accordance with a change in the curvature radius R2 in order to continuously connect the straight linear part AR1 to the curved part AR3. Specifically, this change is represented by W2=α/R2+W1, and a is a transition coefficient. That is, the width W2 changes to be inversely proportional to the curvature radius R2. By continuously changing the width of the rib with respect to the curvature radius, the optical loss of the transition portion can be suppressed as much as possible in transitioning from the straight linear waveguide to the bent waveguide.

For the height of the rib, the height H3 of the rib in the curved part (having a constant curvature) AR3 is set to be larger than the height H1 of the rib in the straight linear part AR1. In the curvature transition part AR2, the height of the rib is continuously changed in accordance with a change in the curvature radius R2 in order to continuously connect the straight linear part AR1 to the curved part AR3. Specifically, this change is represented by H2=β/R2+H1, and β is a transition coefficient. That is, the height H2 changes to be inversely proportional to the curvature radius R2.

As described above, in the curvature transition part AR2, the height H2 and the width W2 of the rib optical waveguide are set to increase as the curvature radius R2 decreases. By continuously changing the height of the rib with respect to the curvature radius, the optical loss of the transition portion can be suppressed as much as possible in transitioning from the straight linear waveguide to the bent waveguide.

For example, the following conditions can be adopted as numerical ranges applied to the rib optical waveguide in FIGS. 4A and 4B.
Thickness TH of entire substrate 1 (LN substrate)=0.1 to 1 μm
Height H1 of rib in straight linear part=0.05 to 0.5 μm
Width W1 of rib in straight linear part=0.2 to 5 μm
Height H3 of rib in curved part=0.07 to 0.7 μm
Width W3 of rib in curved part=0.3 to 7 μm
Transition coefficient α=1 to 200 (um²)
Transition coefficient β=0.2 to 20 (um²)

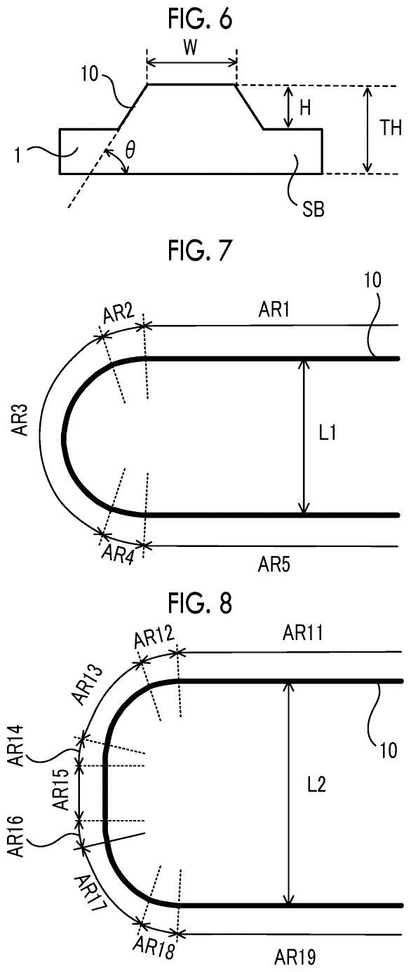

For convenience of a process of forming the optical waveguide, the optical waveguide having the rib shape or the slot shape has a shape in which a side surface of the optical waveguide is not perpendicular to a bottom surface of the LN substrate and is inclined to a center side of the optical waveguide, as illustrated in FIG. 6. An angle θ between the side surface of the optical waveguide and the bottom surface of the substrate is represented by θ=45° to 85°. The values of W1 and W3 described above can be applied to the width W in FIG. 6, and the values of H1 and H3 described above can be applied to the height H in FIG. 6. TH is represented by TH=0.1 to 1 μm.

In the optical waveguide device of the present invention, as illustrated in FIGS. 4A and 4B, the height TH from the bottom surface of the substrate 1 on which the rib optical waveguide 10 is formed, to an upper surface of the rib of the rib optical waveguide is set to be constant even in a case where the height (H1, H3) of the rib optical waveguide changes. Meanwhile, a thickness of a slab waveguide SB changes. Accordingly, it is not necessary to change the thickness of the substrate 1 for each part of the optical waveguide, and a manufacturing process is not complicated. In changing the height (H1, H3) of the rib, a step of adjusting an etching time depending on a location, or uniformly flattening the substrate at the same height first and then, partially trenching the substrate by other means such as an electron beam or a laser may be added. By reducing the thickness of the slab waveguide SB, crosstalk between adjacent optical waveguides can be reduced, and an optical waveguide loss near an electrode (for example, an RF signal action portion or a DC bias action portion) can be reduced.

Next, an example of applying the present invention to a folded waveguide will be described using FIGS. 7 and 8.

In FIG. 7, a folded part is formed with only the curved part (having a constant curvature) AR3, and two curvature transition parts (AR2, AR4) connecting two straight linear parts (AR1, AR5) are used. In this configuration, a space L1 in the vertical direction can be reduced by reducing the curvature while suppressing an optical insertion loss, and this is effective for reducing the chip size.

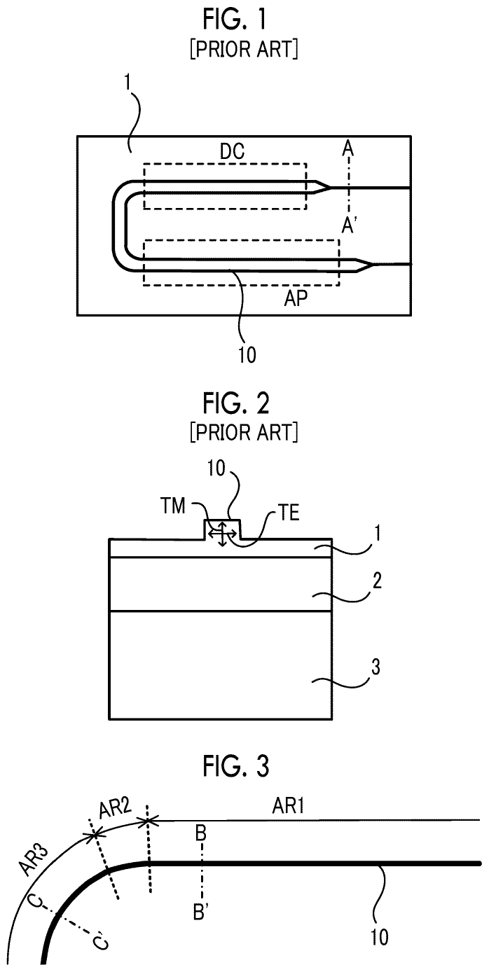

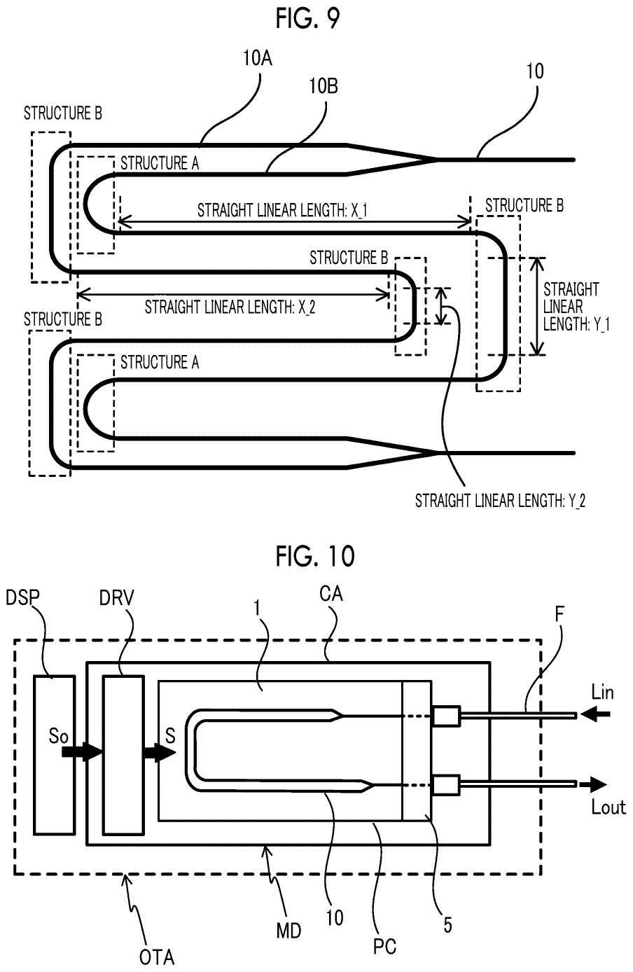

In FIG. 8, a folded part includes two curved parts (AR13, AR17) and a straight linear part AR15 between the curved parts. Curvature transition parts (AR14, AR16) are provided between the straight linear part and the curved parts. Curvature transition parts (AR12, AR18) are also disposed between straight linear parts (AR11, AR19) and the curved parts (AR13, AR17). In this configuration, a space L2 in the vertical direction can be adjusted by reducing the curvature to adjust a length of a straight linear waveguide (AR15) while suppressing an optical insertion loss. Particularly, as an effect of being able to adjust the space L2 in the vertical direction, in a case where two optical waveguides disposed parallel to each other are folded without crossing each other as illustrated in FIG. 1, a space in the vertical direction in the outer optical waveguide needs to be adjusted, and this is effective for adjusting an optical path length. For example, in the folded waveguide structure in FIG. 9, by adopting the structures in FIGS. 7 and 8 in locations of structures A and B, respectively, and adjusting lengths such as X_1, X_2, Y_1, and Y_2, optical path lengths of waveguides 10A and 10B can be set to be equal.

As illustrated in FIG. 9, a compact optical modulation device MD can be provided by accommodating the optical waveguide device (substrate 1) of the present invention inside a case CA of metal or the like and connecting the optical waveguide device to an outside of the case through an optical fiber F. Of course, the optical fiber can not only be directly connected to the input portion or the output portion of the optical waveguide of the substrate 1 but also be optically connected through a space optical system. Reference sign 5 denotes a reinforcing member overlaid on the substrate 1 along an end surface of the substrate 1 and is used in directly joining the optical component such as the optical fiber to the end surface of the substrate 1.

An optical transmission apparatus OTA can be configured by connecting, to the optical modulation device MD, an electronic circuit (digital signal processor DSP) that outputs a modulation signal So causing the optical modulation device MD to perform a modulation operation. A modulation signal S to be applied to the optical waveguide device needs to be amplified. Thus, a driver circuit DRV is used. The driver circuit DRV and the digital signal processor DSP can be disposed outside the case CA or can be disposed inside the case CA. Particularly, disposing the driver circuit DRV inside the case can further reduce a propagation loss of the modulation signal from the driver circuit and achieve a wide bandwidth.

### INDUSTRIAL APPLICABILITY

As described above, according to the present invention, an optical waveguide device that is capable of reducing a curvature radius of an optical waveguide and that suppresses coupling between a TE mode and a TM mode can be provided. An optical modulation device and an optical transmission apparatus using the optical waveguide device having such an advantageous effect can be provided.

### REFERENCE SIGNS LIST

1 Substrate
2 Intermediate layer
3 Holding substrate
10 Optical waveguide (rib optical waveguide)
AR1 Straight linear part of optical waveguide
AR2 Curvature transition part of optical waveguide
AR3 Curved part (having constant curvature) of optical waveguide

1. An optical waveguide device comprising:
a rib optical waveguide,
wherein the rib optical waveguide includes a straight linear part and a curved part configured to have a constant curvature, a curvature transition part in which a curvature continuously changes connects the straight linear part to the curved part,
a height and a width of the rib optical waveguide are different between the straight linear part and the curved part, and
the curvature transition part is formed such that the height and width of the rib optical waveguide continuously change from a height and a width of the straight linear part to a height and a width of the curved part, respectively.

2. The optical waveguide device according to claim 1,
wherein a relationship between the height and width of the rib optical waveguide is such that a value of the height is smaller than a value of the width.

3. The optical waveguide device according to claim 1, wherein,
in the curvature transition part, the height and width of the rib optical waveguide are set to increase as a curvature radius decreases.

4. The optical waveguide device according to claim 1,
wherein a height from a bottom surface of a substrate on which the rib optical waveguide is formed, to an upper surface of a rib of the rib optical waveguide is set to be constant even in a case where the height of the rib optical waveguide changes.

5. An optical modulation device comprising:
the optical waveguide device according to claim 1;
a case accommodating the optical waveguide device; and
an optical fiber through which a light wave is input into the optical waveguide device or output from the optical waveguide device.

6. The optical modulation device according to claim 5, wherein
a modulation electrode that modulates a light wave propagating through the optical waveguide is provided in the substrate, and
an electronic circuit that amplifies a modulation signal to be input into the modulation electrode is provided inside the case or outside the case.

7. An optical transmission apparatus comprising:
the optical modulation device according to claim 6; and
an electronic circuit that outputs a modulation signal causing the optical modulation device to perform a modulation operation.
